(19) United States
(12) Patent Application Publication
(10) Pub. No.: US 2015/0206042 A1
(43) Pub. Date: Jul. 23, 2015

(54) PAPERLESS RECEIPT RECORDING CARD

(71) Applicant: MARCUS LUDLOW, Wasaga Beach (CA)

(72) Inventor: MARCUS LUDLOW, Wasaga Beach (CA)

(21) Appl. No.: 14/598,584

(22) Filed: Jan. 16, 2015

Related U.S. Application Data
(63) Continuation of application No. 61/928,710, filed on Jan. 17, 2014.

(51) Int. Cl. G06K 19/077; G06Q 20/04; G06Q 20/20; G06Q 20/34; G06K 7/00; G06K 19/12

(52) U.S. Cl. CPC G06K 19/07707; G06K 7/006; G06K 19/12; G06Q 20/204; G06Q 20/341; G06Q 20/0453

(57) ABSTRACT

An electronic receipt card (ERC) is disclosed to replace paper receipts. The ERC allows a purchaser to keep a record of all his/her transactions in one location which can be carried along in the wallet along with other cards. This portable card can be presented at point of sell device transmitting the information from the cashier to the purchaser's card. Security procedures also verify the receiving device to avoid inadvertent transmissions and to provide addition security for the transmission. The transaction data received by the ERC is stored in the card and can be later uploaded into other electronic media, or display on the ERC card or through the ERC card reader device.

### RELATED APPLICATION

This application claims the benefit of U.S. Provisional Patent Application No. 61/928,710 filed Jan. 17, 2014.

### FIELD OF THE INVENTION

This invention is a device to replace paper receipts to purchasers with an electronic transaction, allowing for transfer of purchased items and their prices from the cashier to the device.

### BACKGROUND OF THE INVENTION

Currently retail stores provide paper receipts to the merchants reflecting purchases by customer. A paper receipt may include specific information of the purchase. Traditionally the merchant passes the paper receipt to the customer. These paper receipts provide documentation of the purchase which the customer must keep for return or warranty.

Like all paper-based document systems, paper receipts require large amount of storage space, which adds further expenses to a business or individuals. Although there have been significant advancements in the electronic transactions, still almost all common transactions involve issuance of a paper receipt. A purchaser would like to have a paper receipt as proof of his/her purchase, and to keep a record of the purchase. Purchaser can always refer to the paper receipt to check the accuracy of recording, the values of the products, and perhaps in returning the purchased item.

Although the current state of technology allows for the development of an electronic transaction means, still current transaction almost always involves paper receipts. One reason for this is lack of existence of a simple device that can be carried with the purchaser to record and store the purchased items, the exact copy of what would be on a paper receipt. The currently available devices are mainly bulky and not suitable for carrying inside a wallet or pocket.

Although there are several different paperless electronic receipts in the prior art, they are mainly designed for the use by the businesses and not by the individual purchaser. There remains a need for a method and system that eliminates the need for a paper receipt following a commercial transaction. The present device provides a mechanism for immediate transfer of purchased items from the seller to the buyer's device.

### SUMMARY OF THE INVENTION

The present invention is related generally to a device to provide paperless receipt for managing transactions and specifically to an electronic receipt card (ERC) to store and display receipt information, and an electronic card reading device for reading the data stored in the electronic receipt card which can be easily carried by purchasers.

It is an object of the present invention to have an improved and portable device for any person to have the receipt information at any time and place.

It is another object of the present invention to reduce the waste of paper and litter and be more “green”.

The first embodiment of an electronic receipt card device for storing and reading the receipt information stored in an electronic receipt card by electrically bringing the electronic card into contact with the reading device and for displaying the data stored thereof comprising of an electronic receipt card having an electronic display panel, a gate driver, a source driver, an interface, a circuit and a battery and an electronic card reading device for reading the information stored in said electric receipt card.

The gate driver and the source driver of said electronic receipt card are coupled to and disposed on the electronic display panel. The interface, the circuit and the battery may be disposed on a circuit board and may be encased in housing. A memory is coupled to a microprocessor for storing data. At the time of purchase a customer gives the cashier the electronic receipt card upon which a receipt is to be stored. The cashier inserts the electronic receipt card in the docking station. Therefore there is a docking station in any vendor machine. This process is in the same time that the payment is made by the customer. When the payment is made a receipt generator, generates an electronic receipt and a transmitter sends it to the electronic receipt card. The electronic receipt will be saved in the memory, or appear on the electronic receipt card screen.

An electronic card reading device for reading the receipt information stored in the electronic receipt card by electrically bringing the electronic receipt card into contact with the reading device and for displaying the data stored in the memory comprising of a main unit in the form of a thin plate having card contacts which are electrically brought into contact with said electronic receipt card, an integrated circuit, and a display on which to display the data which is read from the electronic card, a power source in the form of a thin plate which is electrically connected to the main unit to supply power thereto, and a card pocket which is to so disposed that the electronic receipt card can be inserted therein and make contact with the card contacts of the main unit.

The first embodiment of the present invention is an electronic receipt card (ERC), comprising of a wallet size card having a data storing memory. At the time of purchase, the electronic receipt card (ERC), is inserted in vendor's machine, which is simply a docking system for ERC. As the purchased items are scanned by the vendor's machine, the information related to the purchased items will store in the memory. Customer may then use a personal computing device to access such electronic receipt, or easily use the receipt card reading device of the present invention which can be easily carried and used at the time of purchase.

In another embodiment of the present invention the electronic receipt card (ERC) comprises of a wallet size card having a display screen to display the receipt information of the purchased item, At the time of purchase the ERC is inserted in vendor's machine, which is simply a docking system for ERC. As the purchased items are scanned by the vendor's machine, they will appear on the ERC's screen and stored in the memory. Therefore at any point of sale (POS) terminal, there would be a docking system for ERC.

The electronic receipt card of the present invention is a pocket size device with capability of storing the electronic receipt to provide the information of the purchased item, such as item number, bar code, date, time, location, purchase total, payment type, tax amount, discount and other information. ERC card is also capable to provide various types of information about the store, such as sale opportunities. ERC is also capable to collect information of grocery stores, shopping malls, wholesalers or other providers of goods or services. ERC card is also capable to communicate with POS terminals and personal computers.

The electronic receipt card of the present invention can also be provided with a variety of menus which permits the user to find the specific item with lower price in selected stores, the ERC may further inform the user of cashiers of the errors in the calculation of discounted goods, which are not considered by scanning.

With ERC, individuals need no longer worry about saving their printed receipt. Users of the card will be able to access all information to the purchased items from particular stores. This feature will bypass the need of saving paper receipts for returns and exchange of purchased items. These features will further decrease the demand on receipts printed out in the stores and lower the costs directed at paper receipt printing material and maintenance of the machines. With the ERC, the customer will also be able to save the specific information like warranty cut off dates onto the secured memory of the ERC card. This invention also includes a method of conducting a categorized purchased list of items to the user, which is useful for any household to programming for living expenses.

It is an objective of the present invention to allow for paperless receipt transactions. It is another objective of the present invention to produce a receipt at the location of transaction. It is another objective of the present invention to provide a wallet size device that is capable of receiving, storing and displaying transaction information.

It is yet another objective of the present invention to provide an electronic card that is easily carried at all times, can be carried by almost everyone, and is usable everywhere.

It is yet another objective of the present invention to provide a unique electronic receipt card that cannot be copied by others except for the particular purchaser, for which the receipt is originally provided, thus reducing the likelihood of fraudulent return and exchange of goods that were not purchased.

Advantages gained by this art include material and labor cost savings as compared to generation of paper receipts, and convenience for both the purchaser and vendor, as well simple electronic storing of all receipts.

Other objects, features, and advantages of the present invention will be readily appreciated from the following description makes reference to the accompanying drawings, which are provided for illustration of the preferred embodiment. However, such embodiments do not represent the full scope of the invention.

### BRIEF DESCRIPTION OF DRAWINGS

Embodiments hereinafter be described in conjunction with the appended drawings provided to illustrate and not to limit the scope of the claims, wherein like designations denote like elements, and in which:

FIG. 1 illustrates a wallet size electronic receipt card capable of receiving, displaying, and storing purchased data, showing the front, the back and the side view of the card;

FIG. 2 (a-b) are a diagram illustrating an electronic receipt card according to an embodiment of the present invention;

FIG. 3 shows a schematic diagram of the purchasing process and generating an electronic receipt and transmits to the electronic receipt card;

FIG. 4 illustrates a wallet size electronic receipt card docketed at Point-of-Sale (POS) vendor device to receive data from the vendor/cashier;

FIG. 5 is a perspective view of an electronic receipt card reader device according to an embodiment of the present invention;

FIG. 6 is a sectional view of the electronic receipt card reader device shown in FIG. 5; and

FIG. 7 is a block diagram of the electronic receipt card reader device shown in FIG. 5.

### DESCRIPTION OF THE PREFERRED EMBODIMENT

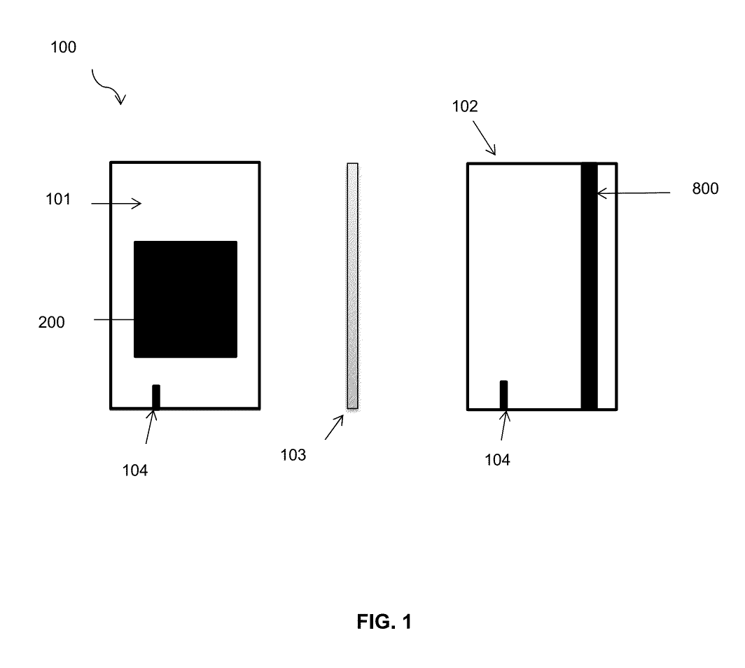

Referring to FIG. 1, an electronic receipt card (ERC) 100 is shown, according to an embodiment of the present invention, which is capable of receiving, storing and displaying electronic data. One embodiment of the electronic receipt card (ERC) 100 disclosed here comprises of a wallet size card having a front side 101, a back side 102 and a thickness 103. Preferably, the electronic receipt card (ERC) 100 is formed from plastic, metal or other suitable material, and may for example have dimensions approximately 85 mm by 55 mm by 2 to 4 mm. The preferred thickness is one that is sufficient to allow a connector to be inserted into a slot 104 on the device thickness to connect to a personal computer. In an embodiment of the present invention the information stored in the electronic receipt card can be display on personal computer through said slot 104. The preferred thickness of the electronic receipt card ERC should not exceed 4 mm. In one embodiment of the present invention ERC comprises of a display screen 200 on the front side. Any type of thin display screen can be used. LCD or LED screens with and without touch sensitive capabilities.

The display will show the information with several choices. The user can select any choices by pressing select keys. By pressing or touching (in touch screen display) select keys, an indicator will point at one of the choices or go to a next level of information. By this the user will have the ability to view the specific purchase receipt, categorize each purchased item from an electronic receipt into user-generated categories or other information such as list of store purchased, extended warranties and warranty cut off dates for purchased items.

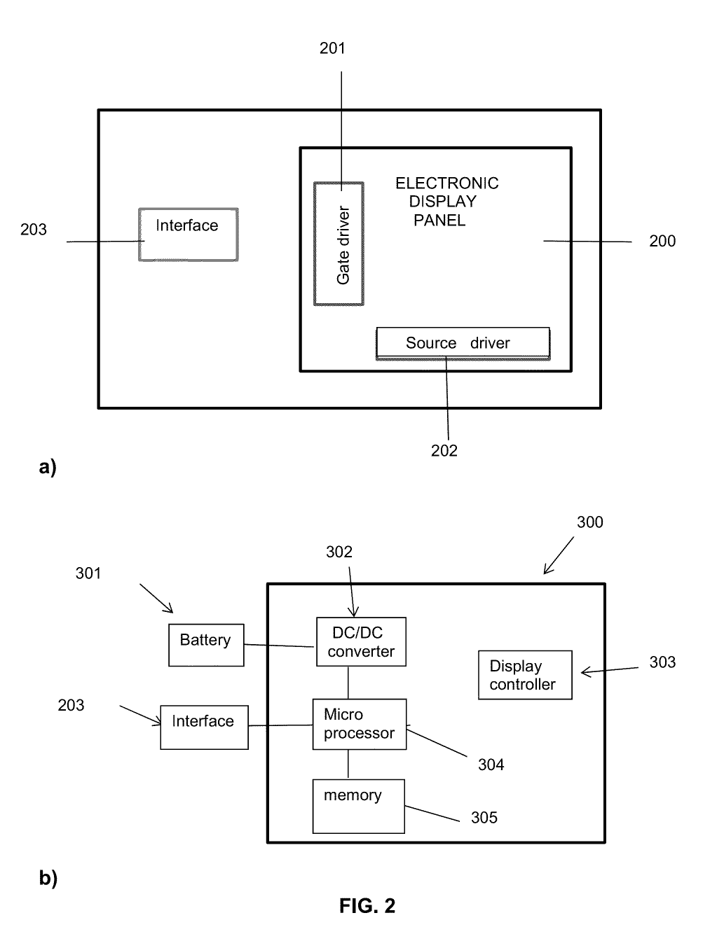

Referring to FIG. 2 (a-b), two diagrams illustrate an electronic receipt card 100 according to an embodiment of the present invention. The electronic receipt card 100 may include an electronic display panel 200, a gate driver 201, a source driver 202, a communication interface 203, an integrated circuit 300, and a battery 301. The gate driver 201 and the source driver 202 are coupled to and disposed on the electronic display panel 200, the communication interface 203, the integrated circuit 300 and the battery 301 may be disposed on a printed circuit board and may be encased in housing. The display panel 200 is an electrophoretic display panel on front side having a display screen to display the purchased items, replicating a receipt.

The gate driver 201 is for providing gate driving signals to the electronic display panel 200, and the source driver 202 is for providing source driving signals to the electronic display panel 200.

The battery 301 may be any chargeable or replaceable battery, which is coupled to the integrated circuit 300, for providing power to the integrated circuit 300. The integrated circuit 300 is coupled to the gate driver 201 and the source driver 202 for providing control signals to the gate driver 201 and the source driver 202. The integrated circuit 300 may include a DC/DC converter 302, and a display controller 303, a micro processor 304 and a memory 305. The DC/DC converter 302 is coupled to the battery 301, for converting the power provided by the battery 301. The display controller 303 is coupled to the gate driver 201 and the source driver 202 for providing the control signals to the gate driver 201 and the source driver 202.

The microprocessor 304 is coupled to the display controller 303, the DC/DC converter 302, and the interface 203 for communicating with other devices. The memory 305 is coupled to the microprocessor 304 for storing data.

At the time of purchase, the ERC is inserted in vendor's machine, which is simply a docking system for ERC 100. As the items are scanned by the cashier or the vendor's machine, the electronic receipt will be saved in the memory, or appear on the ERC screen 110. Therefore, at any point of sale (POS) terminal, there would be a docking system for ERC.

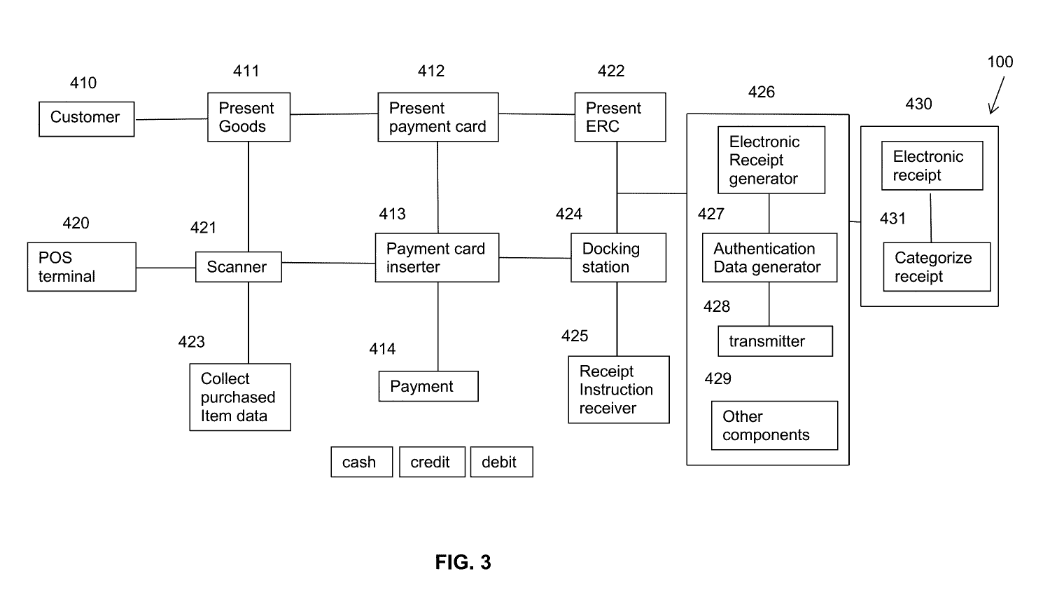

According to the present invention and referring to FIG. 3, a customer 400 approaches to a point-of-sale (POS) environment to pay for some product using any known methods. For example customer may use cash, check, credit card or other well-known payment mechanisms. The POS includes any components for conducting the transaction, for instance monitor, bar code scanner, telecommunications system, credit card authentication system and other methods. Once POS concludes the sales transaction an electronic receipt is generated on the display in accordance with the invention. The customer gives the cashier the ERC 100 upon which a receipt is to be recorded. The cashier inserts the electronic receipt card into the docking station of the POS terminal and when payment is made the receipt is send into ERC memory. The storing of a receipt on an ERC 100 is applicable to all types of transactions, regardless of how payment is made.

FIG. 3 is a diagram of point-of-sale terminal 420 and an electronic receipt generation 430 environment in accordance with the present invention. POS terminal 420 includes a scanner 421, a payment card inserter 413, and a docking station 424 for inserting an electronic receipt card, an electronic receipt generator 426 including an authenticating data generator 427, a transmitter 428 and other components 429. In this environment, generating an electronic receipt 430 begins by a customer 410 presenting goods 411 for purchase. The customer 410 presents the payment card 412 to the cashier to insert in the payment card inserter 413. The customer 410 may pay using any known methods 414. For example, customer 410 may use cash, check, credit card, debit card and other methods 414. The customer 410 will also provide the electronic receipt card (ERC) 100 to the cashier to save the information thereon. The cashier inserts the electronic receipt card in docking station 424. Receipt instruction receiver 425 is configured to receive a receipt instruction, and may take the form of an electronic receipt for forwarding to the electronic receipt card.

Electronic receipt generator 426 is configured to gather any data desired by the customer 410 per content instruction to be provided in electronic receipt 430, and generate electronic receipt. For example, generator 426 would gather: transaction date and time; store name; issuing person, store location in the same fashion for all customer. Alternatively, personalized electronic receipts based on content instruction may also be possible. Authentication data generator 427 may also be implemented to provide transaction authentication data to prove the authenticity of electronic receipt 430. Transmitter 428 is provided to communicate electronic receipt 430 to the electronic receipt card 100. Electronic receipt 430 may also be communicated to store system. Transmitter 428 transmits authentication data to store system and stores it for access by the purchaser later whenever is needed. Transmitter 428, transmits the electronic receipt 430 to the electronic receipt card 100 that is inserted in the docking system 424 of the POS 420. Each of these process may be similar to generating an electronic receipt but include mechanisms to take advantage of storing all information of purchased items in an electronic receipt card. Furthermore the advantages for receiving an electronic receipt and access to appropriate applications such as categorizing 431 each item on electronic receipt, for example clothing, food or capable to categorize electronic receipts by stores, or large gifts.

Referring again to FIG. 3 information of the goods being purchased is collected 423. Thus, each personal electronic receipt may include itemized serial numbers (S/N), transaction date, time, merchant name, store information. The information will be captured by scanning 421 and an electronic receipt 430 will be generated.

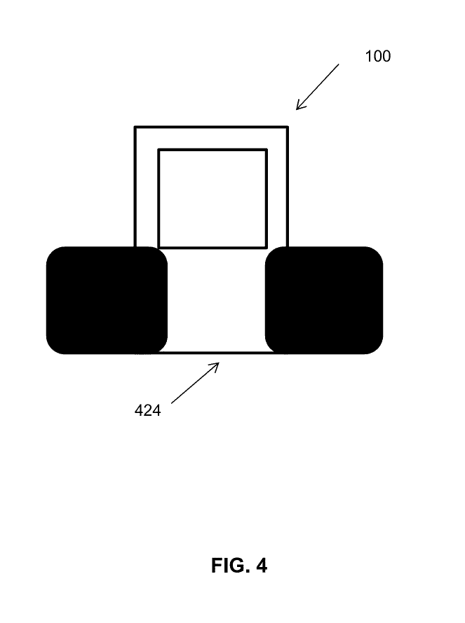

Referring to FIG. 4, showing a docking system for an electronic receipt card. The information of the electronic receipt will be saved in the memory of the docketed electronic receipt card (ERC) or will appear on the display. Referring again to FIG. 3 electronic receipt 430 will categorize the purchased goods based on items, date of purchase or based on store and other standard or personalized data's.

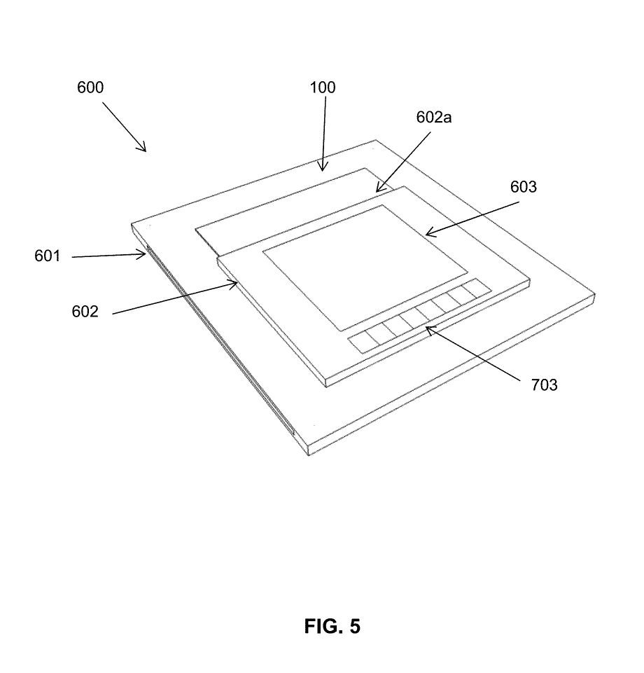

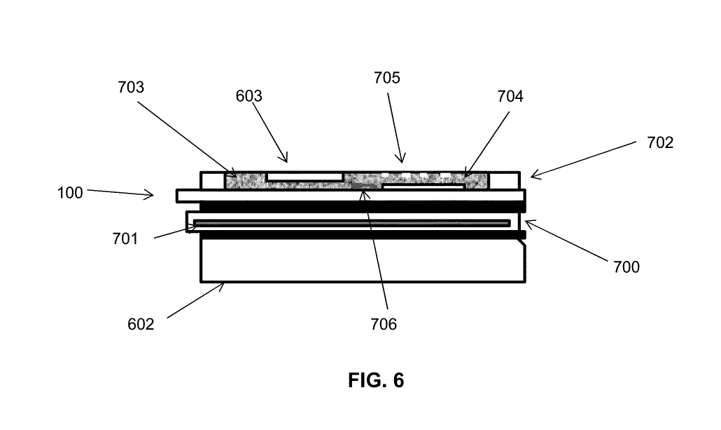

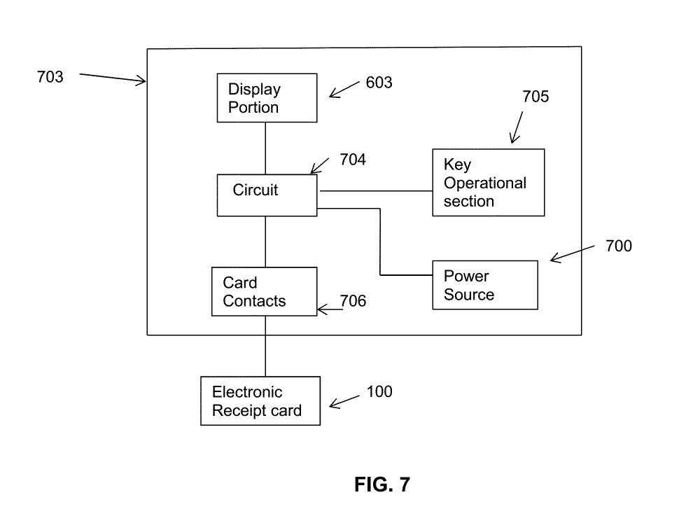

Referring to FIG. 5 and FIG. 6, in preferred embodiment the electronic receipt card accompanies by an electronic card reading device 600 which is carried by the customer to reading the information stored in the electronic receipt card 100. Said card reader device has a thin, rectangular case 601 and a card pocket 602 which is open in one side, thereby forming an opening 602a. A thin rectangular power source housing portion 700 is formed on the upper piece constituting the card pocket. Inside the power source housing portion 700, is a thin sheet-type battery 701 which has the same structure as the battery. There is a thin rectangular card pocket 602 with an opening 602a to insert the electronic receipt card 100 on one side. The main unit housing portion 702 is electrically connected to a sheet type battery 701 accommodated in the power source housing portion 700 by a connecting member. Inside the main unit 703, an integrated circuit 704 is disposed. Display portion 603 and key operational section 705 are disposed on upper surface of the main unit 703. The card contacts 706 protrude through the main unit housing portion 702 into card pocket 602 so that the card inserted in the card pocket comes into contact with the end tip of the card contacts 706 and is electrically connected thereto. FIG. 7 is a block diagram of the card reading device of this embodiment.

The card reader portion are made thin and formed to be equivalent to the thickness of the electronic receipt card.

The ERC can also be equipped with a standard magnetic strip which will include buyer's information. The magnetic strip can be used for security, authenticity of the buyer and other commercial and banking information. In addition to the magnetic strip, a barcode can be added to the card to also allow the consumer code to be read by a barcode scanner.

ERC's can have different size memories. A low cost ERC will have a small memory, whereas, a relatively costlier ERC can have a large memory to store several gigabytes of data, which translates to a life time of purchasing records. Small memory ERC can later transfer their data to another computer or machine. Therefore, personal docking system can be obtained by any purchaser or consumer to connect the card to another computer or machine and download the information on the ERC to another computer or a permanent storage location.

ERC may constitute a primary data that identifies at least one of the purchased information or a combination of available data that creates purchase information such as, transaction amount, date, time, type, tax, and other information.

The ERC is designed to provide data processing means, data storage means and media interface means. A card micro-module provides protected data processing and data storage means, as well as controlling other electronic components. Micro-modules are used in so called smart cards, with a variety of memory and microprocessor based micro-modules already in existence. One definition of a micro-module is a microprocessor with connected nonvolatile memory, which includes special physical and logical measures to prevent unauthorized data access and processor instruction reverse engineering.

In another embodiment of the present invention, the ERC may be equipped with a radio frequency transceiver which typically operates at very short ranges and for frequencies preferably in the low frequency range. The radio frequency transceiver provides extremely fast interactive communication between ERC and a radio frequency communications device or another ERC. This allows for data transfer to be performed automatically, with the ERC owner only required to optionally approve the amount and/or enter a password. Power is supplied by a replaceable battery, with power supplied to the ERC micro-module, and to external cards or attachments via the smart card reader/writer. Solar cells or other power supply means could also be used to augment or replace the battery. The ERC has a media attachment, with a card slot allowing a generic attachment card, generic multimedia card or smart card to be connected to a media attachment, with data and/or power exchange occurring via an attachment interface. A variety of small sized, highly functional attachments can be used as required.

While the subject invention has been described with reference to the preferred embodiments, it should be understood that various changes and modifications could be made therein, by one skilled in the art, without varying from the scope and spirit of the subject invention as defined by the appended claims.

The forgoing is considered as illustrative only of the principles of the invention. Further, since numerous modification and changes will readily occur to those skilled in the art, it is not desired to limit the invention to the exact construction an operation shown and described, and accordingly, all suitable modifications and equivalents may be restored to, filling within the scope of the invention.

With respect to the above description, it is to be realized that the optimum relationship for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. An electronic receipt card for storing and providing a receipt information comprising;
a. a wallet size card, having a front side, a back side and a thickness;
b. said receipt card comprising:
i. a circuit board, an electronic display panel disposed on said circuit board, a gate driver disposed on and coupled to said display panel, a source driver coupled to and disposed on said display panel, a communication interface disposed on said circuit board and a circuit, said circuit comprising: a DC/DC converter coupled to a power source, and a microprocessor for processing data;
ii. a memory coupled to said microprocessor for storing a purchase information;
iii. said power source disposed on said circuit board for providing and storing electric power;
c. a docking station to receive said receipt card, to create an electronic receipt containing information about a purchased item comprising:
i. a card reader for reading the information on said receipt card, wherein said information including purchaser information, purchased item information, transaction information and generate an electronic receipt;
ii. a transmitter for sending an electronic receipt to the memory of the electronic receipt card, whereby the docking station being at any point of sale,
d. an electronic receipt card reading device for reading the data stored in an electronic receipt card by electrically bringing said receipt card into contact with said reading device, wherein said reading device comprising:
i. a thin main unit having card contacts which are brought electrically into contact with an electronic card, a circuit and a display portion for displaying the data which is read from the electronic card and a main housing portion for said main unit;
ii. a thin power source being electrically connected to said main unit to supply power thereto, and another housing portion for said power source unit;
iii. an electronic card pocket being disposed in said card reader to receive said electronic receipt card, whereby, said receipt card being inserted therein and brought into contact with said card contacts of said main unit,
whereby said electronic receipt card being used for return and exchange purchased items and to provide the purchaser the purchase information comprising: an item number, a date and time of a purchase, a purchase location, and a payment type.

2. The electronic receipt card of claim 1, wherein said receipt card and device being a pocket size device capable of storing and displaying information of purchased item, and capable of being easily carried and used by a purchaser.

3. The electronic receipt card of claim 1, wherein said electronic receipt card further having a plurality of applications to provide purchased item information, wherein said applications provide: a specific purchase receipt; categorize each purchase item based on personalized information, purchase price, item's serial number, item type, brand name, date of purchase, warranty information, and return and exchange due date.

4. The electronic receipt card of claim 1, wherein said electronic receipt card having a standard magnetic strip for security, authenticity and reducing of fraudulent return an exchange of goods.

5. The electronic receipt card of claim 1, wherein said receipt card having a slot to allow a connector to be inserted therein to display the information stored in said card on a personal computer.

6. The electronic receipt card of claim 1, wherein said receipt card having a display screen on front side to display information stored in said electronic card.

7. The electronic receipt card of claim 6, wherein said electronic receipt card is configured to present a user interface display for enabling user selection of the plurality of purchased application for use.

8. The electronic receipt card of claim 6, wherein said display means being any one of thin LCD or LED display screens with or without touch sensitive capability.

9. The electronic receipt card of claim 1, wherein said electronic receipt card being programmed with a plurality of applications to provide purchased item information, wherein the user can select any choices by touching the touch sensitive display and can have the ability to view the specific purchased receipt, categorize each purchase item based on the personalized information.

10. A method of using electronic receipt card for paperless transaction, said method comprising steps of:
a. receiving payment for the purchased goods and select the receipt option by the consumer for transaction;
b. inserting an electronic receipt card into said docking station of claim 1 at POS;
c. collecting purchased item data;
d. collecting authentication data for purchaser; and
e. generating an electronic receipt, and transmitting information data to the electronic receipt card.

11. A method as in claim 10, wherein said identification data comprises of personal information of the person presenting the item.

12. A method as in claim 10, wherein said identification data for purchased item comprises of serial number and other information of the purchased item.

13. A method as in claim 10, wherein said generated receipt includes purchaser information and purchased item information.

14. A method as in claim 10, wherein said electronic receipt is passed to the electronic receipt card through docking system and stored in the memory of said card.
